(19) United States
(12) Patent Application Publication
(10) Pub. No.: US 2026/0128210 A1
(43) Pub. Date: May 7, 2026

(54) COIL COMPONENT

(71) Applicant: SAMSUNG ELECTRO-MECHANICS CO., LTD., Suwon-si (KR)

(72) Inventors: Tae Hyun KIM, Suwon-si (KR); Ju Hyoung PARK, Suwon-si (KR); Soon Kwang KWON, Suwon-si (KR); Woo Jin KIM, Suwon-si (KR); Dong Jin LEE, Suwon-si (KR)

(73) Assignee: SAMSUNG ELECTRO-MECHANICS CO., LTD., Suwon-si (KR)

(21) Appl. No.: 19/314,232

(22) Filed: Aug. 29, 2025

(30) Foreign Application Priority Data
Nov. 4, 2024 (KR) 10-2024-0154648

(51) Int. Cl. H01F 27/29; H01F 27/02; H01F 27/32

(52) U.S. Cl. CPC H01F 27/292; H01F 27/02; H01F 27/32

(57) ABSTRACT

A coil component includes a body having a first surface and a second surface opposing each other in a first direction, and a plurality of side surfaces connecting the first and second surfaces. The body includes a magnetic material and houses a coil. First and second external electrodes are spaced apart from each other on the body in a second direction and are connected to respective ends of the coil. The body further includes a molded portion in which the coil is disposed and a cover portion that contacts the molded portion. A relief pattern protrudes from the surface of the cover portion that faces the molded portion. When viewed in the first direction, at least a portion of the relief pattern overlaps the coil. The structure is designed to improve reliability by suppressing stress propagation and crack formation during manufacturing or operation.

### CROSS-REFERENCE TO RELATED APPLICATION(S)

This application claims the benefit of priority to Korean Patent Application No. 10-2024-0154648 filed on Nov. 4, 2024 with the Korean Intellectual Property Office, the disclosure of which is incorporated herein by reference in its entirety.

### TECHNICAL FIELD

The present disclosure relates to a coil component.

Inductors, coil components, are representative passive electronic components used in electronic devices along with resistors and capacitors.

Inductors applied to PC-related components, such as DDR 5, have been developed toward high efficiency and large sizes due to the characteristics of components using high currents.

The body of a large inductor may be divided into a cover portion and a remaining portion in which a coil is disposed inside using a single mold. Cracks may occur therebetween due to differences in applied materials and pressing conditions.

### SUMMARY

An aspect of the present disclosure is to provide a coil component with improved reliability by controlling crack occurrence in a magnetic body.

According to an aspect of the present disclosure, a coil component includes: a body including a first surface and a second surface opposing each other in a first direction and a plurality of side surfaces connecting the first surface and the second surface and including a magnetic material; a coil disposed within the body; and first and second external electrodes disposed to be spaced apart from each other on the body in a second direction and connected to both ends of the coil, wherein the body includes a molded portion in which the coil is disposed and a cover portion including one surface in contact with the molded portion, a relief pattern protrudes from the one surface of the cover portion, and when viewed in the first direction, at least a portion of the relief pattern overlaps the coil.

According to another aspect of the present disclosure, a coil component includes: a body including a first surface and a second surface opposing each other in a first direction and a plurality of side surfaces connecting the first surface and the second surface and including a magnetic material; a coil disposed within the body and forming at least one turn; and first and second external electrodes disposed to be spaced apart from each other on the body in a second direction and connected to both ends of the coil, wherein the body includes a molded portion in which the coil is disposed and a cover portion including one surface in contact with the molded portion, a relief pattern protrudes from the one surface of the cover portion, and when viewed in the first direction, the relief pattern is spaced apart from the plurality of side surfaces of the body.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to an embodiment of the present disclosure;

FIG. 2 is a cross-sectional view taken along line I-I′ of FIG. 1;

FIG. 3 is a view viewed in an X-direction of FIG. 1;

FIG. 4 is an enlarged view of each of A and B of FIG. 2;

FIG. 5 is an enlarged view of each of A and B of FIG. 2 as a modified example;

FIGS. 6A to 6E are views of a cover portion of FIG. 1 viewed in the X-direction;

FIGS. 7A to 7E are views of the cover portion and coil of FIG. 1 viewed in the X-direction;

FIG. 8 is a perspective view schematically illustrating a coil component according to another embodiment of the present disclosure;

FIG. 9 is a cross-sectional view taken along line II-II′ of FIG. 8; and

FIG. 10 is a view of FIG. 8 viewed in the X-direction.

### DETAILED DESCRIPTION

The terms used herein to describe embodiments of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

The terms used in the present specification are merely used to describe particular embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but should be used as a concept encompassing even a case in which another component is disposed between each component so that a component is in contact with the other component.

Since the size and thickness of each component illustrated in the drawings are arbitrarily illustrated for convenience of description, the present disclosure is not necessarily limited to the illustrated.

In the drawings, an X-direction may be defined as a first direction or thickness direction, a Y-direction may be defined as a second direction or length direction, and a Z-direction may be defined as a third direction or width direction.

Hereinafter, a coil component according to an embodiment in the present disclosure will be described in detail with reference to the accompanying drawings, and in the description with reference to the accompanying drawings, the same or corresponding components are assigned the same reference numerals and overlapping descriptions thereof will be omitted.

Various types of electronic components are used in electronic devices, and various types of coil components may be appropriately used between these electronic components for the purpose of removing noise.

That is, in electronic devices, coil components may be used as power inductors, high-frequency (HF) inductors, general beads, GHz beads, common mode filters, etc.

### First Embodiment

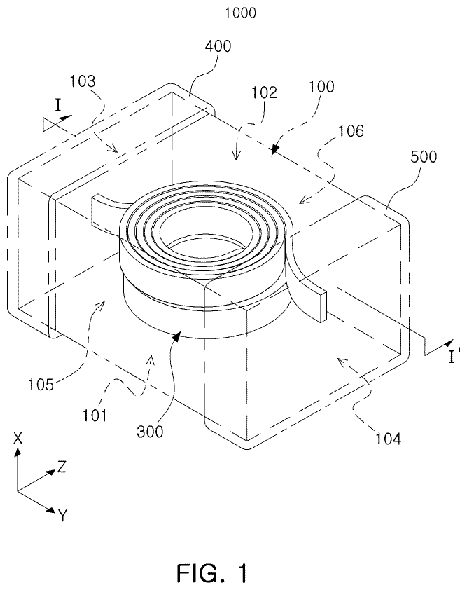

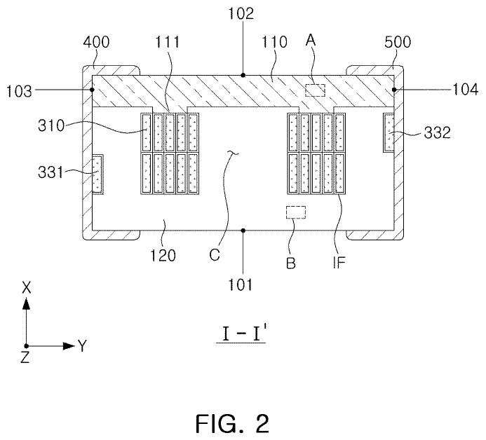

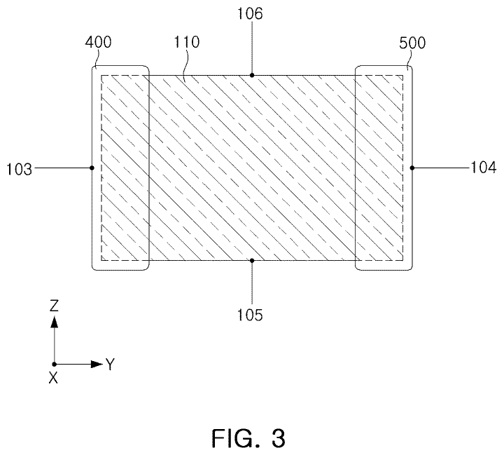

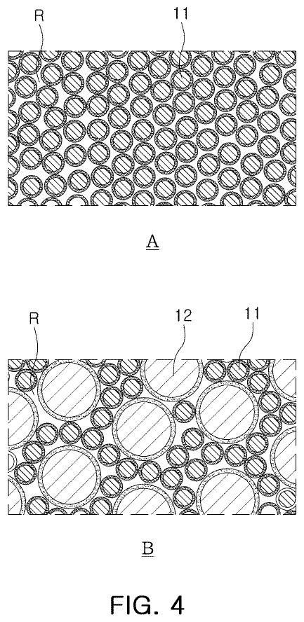

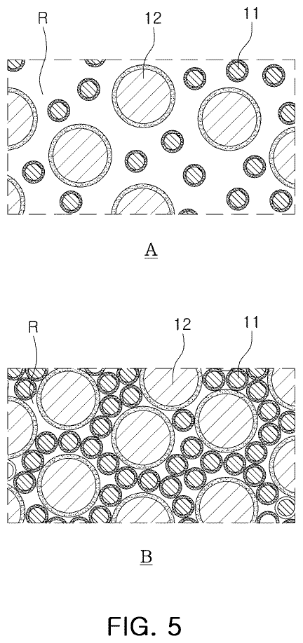

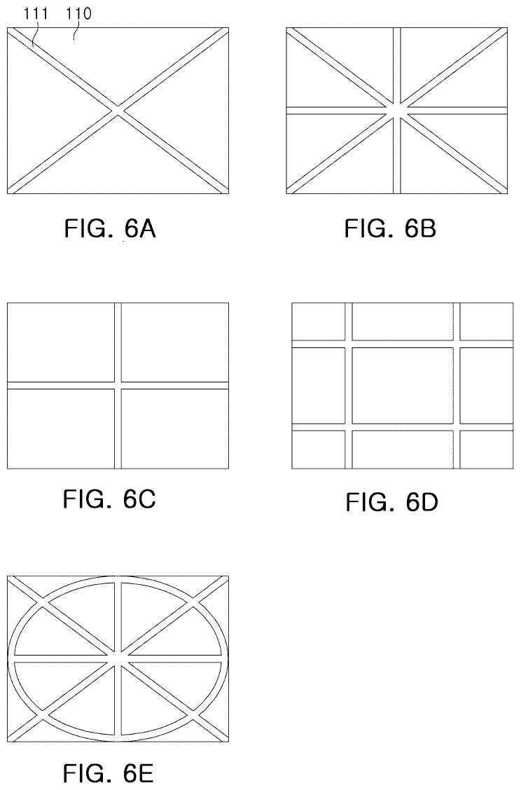

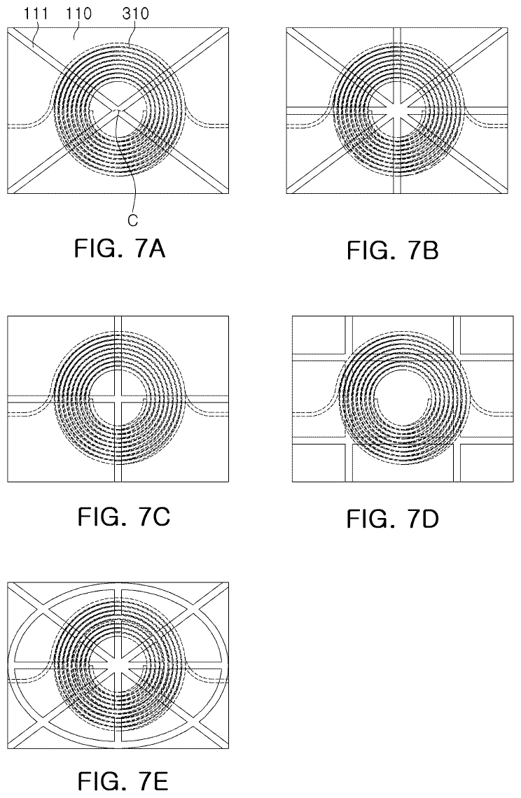

FIG. 1 is a perspective view schematically illustrating a coil component according to an embodiment of the present disclosure. FIG. 2 is a cross-sectional view taken along line I-I′ of FIG. 1. FIG. 3 is a view viewed in an X-direction of FIG. 1. FIG. 4 is an enlarged view of each of A and B of FIG. 2. FIG. 5 is an enlarged view of each of A and B of FIG. 2 as a modified example. FIGS. 6A to 6E are views of a cover portion of FIG. 1 viewed in the X-direction. FIGS. 7A to 7E are views of the cover portion and coil of FIG. 1 viewed in the X-direction.

Referring to FIGS. 1 to 7, a coil component 1000 according to a first embodiment of the present disclosure includes a body 100, a coil 300, and external electrodes 400 and 500.

The body 100 forms the external casing of the coil component 1000 according to the first embodiment, and a coil 300 is embedded therein.

The body 100 may be formed in the shape of a hexahedron as a whole.

Referring to FIG. 1, the body 100 may include a first surface 101 and a second surface 102 opposing each other in the X-direction (the first direction), a first side surface 103 and a second side surface 104 opposing each other in the Y-direction (the second direction), and a third side surface 105 and a fourth side surface 106 opposing each other in the Z-direction (the third direction). Each of the first to fourth side surfaces 103, 104, 105, and 106 of the body 100 corresponds to a plurality of side surfaces of the body 100 connecting the first surface 101 and the second surface 102 of the body 100.

The body 100 may be formed, for example, so that the coil component 1000 according to the present embodiment, in which the external electrodes 400 and 500 described below are formed, has a length of 2.0 mm, a width of 1.2 mm, and a thickness of 0.65 mm, but is not limited thereto. Meanwhile, the aforementioned numerical values are merely design values without reflecting process errors, etc., and therefore, it should be considered that the range that may be recognized as process errors falls within the scope of the present disclosure.

The body 100 may include a molded portion 120 in which a coil 300 to be described below is disposed and a cover portion 110 including one surface contacting the molded portion. Referring to FIG. 2, the body 100 may be divided into the cover portion 110 disposed on top of the coil 300 and other molded portion 120.

The cover portion 110 may be disposed on top of the coil 300, and one surface (a lower surface in FIG. 2) may contact the molded portion 120. The cover portion may include one surface and the other surface (an upper surface in FIG. 2) facing the one surface in the first direction (the X-direction) and a plurality of side surfaces. The other surface of the cover portion may form the second surface 102 of the body 100, and the plurality of side surfaces of the cover portion may form the plurality of side surfaces 103, 104, 105, and 106 of the body 100.

A relief pattern 111 may be formed on one surface of the cover portion 110. The relief pattern 111 may protrude from one surface of the cover portion 110. The relief pattern 111 may play a role in preventing the propagation of stress within the body 100 and controlling the occurrence of cracks due thereto.

The body of a large inductor may be divided into a cover portion and a remaining portion (the molded portion) in which a coil is disposed using a single mold. Cracks may occur therebetween due to differences in applied materials and pressing conditions. Specifically, the cover portion and the molded portion may be sequentially pressed. Due to a difference in stiffness and coefficient of thermal expansion between the cover portion and the molded portion, expansion may occur due to a temperature change, and cracks may occur due to stress propagation caused by expansion.

In the coil component according to the present embodiment, the relief pattern 111 may be formed as a beam-like relief structure on a lower surface of the cover portion 110, that is, an interface in which the cover portion 110 and the molded portion 120 meet, thereby preventing stress propagation and controlling crack occurrence in the body 100 due to stress propagation.

Referring to FIGS. 7A to 7E, when viewed in the first direction (the X-direction), the relief pattern 111 may overlap the coil 300. That is, the relief pattern 111 may be formed across one surface contacting the molded portion 120 and may have a radial shape from the center of one surface to an outer portion. When viewed in the first direction, the relief pattern 111 may overlap a core C of the molded portion 120 to be described below. In the case of the structure as described above, the propagation of stress may be effectively prevented.

The relief pattern 111 may be in direct contact with the coil 300 and may be in contact with an insulating film IF covering the coil 300 to be described below. As illustrated in FIGS. 7A to 7E, the relief pattern 111 may be formed at the center of one surface of the cover portion 110, but the relief pattern 111 may not penetrate through the coil 300. Here, ‘not penetrating through’ may refer to not substantially penetrating through an air core formed by the coil 300. Due to errors in the manufacturing process, the relief pattern 111 may penetrate through a portion of the coil 300 minutely; however, in the present disclosure, a component penetrating through the coil 300 is the molded portion 120, and as to be described below, the molded portion 120 may include a core C penetrating through the coil 300.

At least a portion of the molded portion 120 may be disposed between one surface of the cover portion 110 and the coil 300. Since the relief pattern 111 is a component protruding from one surface of the cover portion 110, at least a portion of the molded portion 120 may be disposed in a region of a lower surface of the cover portion 110 which does not protrude.

The relief pattern 111 may extend to a plurality of side surfaces 103, 104, 105, and 106 of the body 100. However, without being limited thereto, the relief pattern 111 may be formed targeting only a portion in which stress is concentrated and may not extend to the plurality of side surfaces 103, 104, 105, and 106 of the body 100.

The molded portion 120 may be disposed below the cover portion 110 and the coil 300 is disposed therein. The molded portion 120 may refer to a component of the body 100 excluding the cover portion 110. The molded portion 120 may include one surface forming the first surface of the body 100, another surface facing the one surface in the first direction (the X-direction) and contacting the cover portion 120, and a plurality of side surfaces.

The plurality of side surfaces of the molded portion 120 may form a plurality of side surfaces 103, 104, 105, and 106 of the body together with the plurality of side surfaces of the cover portion 110. However, as in a second embodiment described below, the plurality of side surfaces of the molded portion 120 may not form the plurality of side surfaces 103, 104, 105, and 106 of the body.

The molded portion 120 may include the core C penetrating through the coil 300. Here, ‘penetrating through the coil 300’ may refer to penetrating through the air core of the coil 300 forming at least one turn.

The molded portion 120 may be formed by disposing the cover portion 110 in the mold and the coil 300 on one surface of the cover portion 110, filling the mold with a resin and magnetic metal particle described below, and then pressing and heating the mold.

The cover portion 110 and the molded portion 120 may include the resin and magnetic metal particle. Specifically, the cover portion 110 may include a first magnetic metal particle 11, and the molded portion 120 may include a second magnetic metal particle 12.

The cover portion 110 and the molded portion 120 may have different particle size distributions. Specifically, in a cross-sectional sample collected in the X-Y-direction, the particle size distributions analyzed based on the area may be different.

The diameter of the first magnetic metal particle 11 may be different from the diameter of the second magnetic metal particle 12. Meanwhile, in this specification, the difference in the diameters of the magnetic metal particles 11 and 12 may mean that the average diameters are different. In addition, the difference in the average diameters of the magnetic metal particles 11 and 12 may mean that the particle size distribution values expressed as D50 or D90 are different.

Referring to FIG. 4, the cover portion 110 may include only the first magnetic metal particle 11 having a relatively small average diameter. The molded portion 120 may include the second magnetic metal particle 12 which is relatively large and first magnetic metal particle 11. A magnetic particle filling ratio of the cover portion 110 may be greater than that of the molded portion 120. The second magnetic metal particle 12 included in the molded portion 120 has a relatively large average diameter, thereby implementing high magnetic permeability (relative permeability). In addition, the molded portion 120 may further improve the magnetic permeability (relative permeability) and enhance the Q characteristic by improving the filling ratio by mixing the first magnetic metal particle 11 and the second magnetic metal particle 12 together. In addition, the molded portion 120 may be filled with a sufficient amount of magnetic metal particles even when a relatively low pressure is applied, so that a relatively high filling ratio may be secured. Meanwhile, since the cover portion 110 includes only the first magnetic metal particle 11 having a relatively small average diameter, the cover portion 110 may have a relatively low permeability (relative permeability) compared to the molded portion 120, but since it is a low-loss material, it may play a role in compensating for an increased core loss due to the use of a high-permeability material having a relatively large diameter.

However, the present disclosure is not necessarily limited thereto, and the average diameter of the first magnetic metal particle 11 may be larger than the average diameter of the second magnetic metal particle 12.

FIG. 5 is a diagram illustrating an enlarged view of each of A and B of FIG. 2 as a modified example. Referring to FIG. 5, the cover portion 110 may have a higher content of resin R compared to the molded portion 120 and may have a lower filling rate of the metal magnetic particles. Since the resin R content of the cover portion 110 is greater than the resin R content of the molded portion 120, the magnetic metal particles may be firmly bonded together and the mechanical strength may be improved. The resin R content may be obtained as a ratio of the area occupied by the resin R to the total area in a cross-sectional sample collected in the X-Y-direction. Since the cover portion 110 may have a lower filling rate of the metal magnetic particles compared to the molded portion 120, the cover portion 110 may exhibit a relatively low permeability (relative permeability). The filling rate of the metal magnetic particles may be obtained as a volume fraction or area fraction of the metal magnetic particles included in the resin R.

However, the present disclosure is not necessarily limited thereto, and the cover portion 110 may have a lower resin R content compared to the molded portion 120, and the filling rate of the metal magnetic particles may be higher.

The magnetic metal particles 11 and 12 may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal particles 11 and 12 may be at least one selected from the group consisting of pure iron powder particles, Fe—Si alloy powder particles, Fe—Si—Al alloy powder particles, Fe—Ni alloy powder particles, Fe—Ni—Mo alloy powder particles, Fe—Ni—Mo—Cu alloy powder particles, Fe—Co alloy powder particles, Fe—Ni—Co alloy powder particles, Fe—Cr alloy powder particles, Fe—Cr—Si alloy powder particles, Fe—Si—Cu—Nb alloy powder particles, Fe—Ni—Cr alloy powder particles, and Fe—Cr—Al alloy powder particles.

The magnetic metal particles 11 and 12 may be amorphous or crystalline. For example, the magnetic metal particles 11 and 12 may be Fe—Si—B—Cr amorphous alloy powder particles, but are not necessarily limited thereto.

The diameter of the first magnetic metal particle 11 may be 10 μm to 50 μm, and the diameter of the second magnetic metal particle 12 may be 0.1 μm to 6 μm. However, without being limited thereto, the average diameter of the first magnetic metal particle 11 may be greater than the average diameter of the second magnetic metal particle 12.

The surface of each of the magnetic metal particles 11 and 12 may be covered with an insulating material. The insulating material may be an organic insulating material including, but not limited to, epoxy, polyimide, liquid crystal polymer, etc., alone or in combination or may be an oxide insulating film including a metal component of the magnetic metal particles 11 and 12 or an inorganic insulating material, such as SiOₓ, SiNₓ, or phosphate.

The resin R may include epoxy, polyimide, liquid crystal polymer, etc., alone or in combination, but is not limited to.

The coil 300 demonstrates the characteristics of the coil component. For example, when the coil component 1000 of the present embodiment is utilized as a power inductor, the coil 300 may store an electric field as a magnetic field to maintain an output voltage, thereby stabilizing power of an electronic device.

The coil 300 is disposed inside the molded portion 120 of the body 100, and both ends 331 and 332 extend to the surface of the body 100. Specifically, the coil 300 may include a winding portion 310 forming at least one turn with the core C of the molded portion 120 as an axis and first and second lead portions 331 and 332 connected to the winding portion 310 and extending to the first side surface 103 and the second side surface 104 of the body 100, respectively.

The coil 300 may be formed by winding a metal wire, such as a copper wire (Cu-wire) including a metal wire MW and the insulating film IF covering a surface of the metal wire MW. Accordingly, the entire surface of each of the plurality of turns of the coil 300 is covered with the insulating film IF. Meanwhile, the metal wire may be a flat wire, but is not limited thereto. When the coil 300 is formed with a flat wire, as an example, as shown in FIG. 2, the coil 300 may have a shape in which each turn has a rectangular cross-section.

The winding portion 310 may form the innermost turn, at least one middle turn, and the outermost turn toward the outside of the body 100 in the Y-direction (the second direction) or the Z-direction (the third direction) from the core C. The winding portion 310 may have an upper surface and a lower surface similar to a ring shape as a whole and an inner surface and an outer surface connecting the upper surface and the lower surface, so that the winding portion 310 may have a cylindrical shape in which a cylindrical hollow portion is formed in the center. The winding portion 310 is an air core coil, and the core C may be disposed in the air core of the winding portion 310.

The first and second lead portions 331 and 332 may extend to both sides opposing each other in the second direction (the Y-direction) as both ends of the coil 300. Specifically, the first lead portion 331 may extend to the first side surface 103 of the body 100, and the second lead portion 332 may extend to the second side surface 104 of the body 100. The first and second lead portions 331 and 332 may be the remainder remaining after forming the winding portion 310 among metal wires, such as copper wires having surfaces covered with the insulating film IF. As a result, a boundary may not be formed between the first and second lead sections 331 and 332 and the winding portion 310. In addition, the insulating film IF may be formed on the surfaces of the first and second lead portions 331 and 332, similar to the winding portion 310.

The insulating film IF may include epoxy, polyimide, liquid crystal polymer, etc. alone or in combination, but is not limited thereto.

The first and second external electrodes 400 and 500 may be disposed to be spaced apart from each other in the second direction (the Y-direction) on the body 100 and may be connected to both ends of the coil 300.

Specifically, in the present embodiment, the first external electrode 400 may be disposed on the first side surface 103 of the body 100 and connected to the first lead portion 331 extending to the first side surface 103 of the body 100. In addition, the first external electrode 400 may extend from the first side surface 103 of the body 100 to at least a portion of each of the first surface 101, the second surface 102, the third surface 105, and the fourth surface 106 of the body 100. The second external electrode 500 may be disposed on the second side surface 104 of the body 100 and connected to the second lead portion 332 extending to the second side surface 104 of the body 100. In addition, the second external electrode 500 may extend from the second side surface 104 of the body 100 to at least a portion of each of the first surface 101, the second surface 102, the third surface 105, and the fourth surface 106 of the body 100.

The first and second external electrodes 400 and 500 may be formed of a conductive material, such as copper (Cu), aluminum (Al), silver (Ag), tin (Sn), gold (Au), nickel (Ni), lead (Pb), chromium (Cr), titanium (Ti), or alloys thereof, but are not limited thereto.

The first and second external electrodes 400 and 500 may be formed in a single-layer or multi-layer structure. For example, the first external electrode 400 may include a first layer including copper (Cu), a second layer disposed on the first layer and including nickel (Ni), and a third layer disposed on the second layer and including tin (Sn). Each of the first to third layers may be formed by electroplating, but is not limited thereto. Each of the first and second external electrodes 400 and 500 may include a conductive resin layer and an electroplating layer. The conductive resin layer may be formed by applying and curing conductive powder particles including silver (Ag) and/or copper (Cu) and a conductive paste including an insulating resin, such as epoxy.

Meanwhile, although not shown, a surface insulating layer may be formed in regions of the first surface 101, the second surface 102, and the first to fourth side surfaces 103, 104, 105, and 106 of the body 100, excluding regions in which the external electrodes 400 and 500 are disposed. The surface insulating layer may be formed by printing an insulating paste, applying an insulating resin, or stacking an insulating film including an insulating resin on the first surface 101, the second surface 102, and the first to fourth side surfaces 103, 104, 105, and 106 of the body 100. The insulating resin may include, but is not limited to, epoxy, polyimide, liquid crystal polymer, etc. alone or in combination.

### Second Embodiment

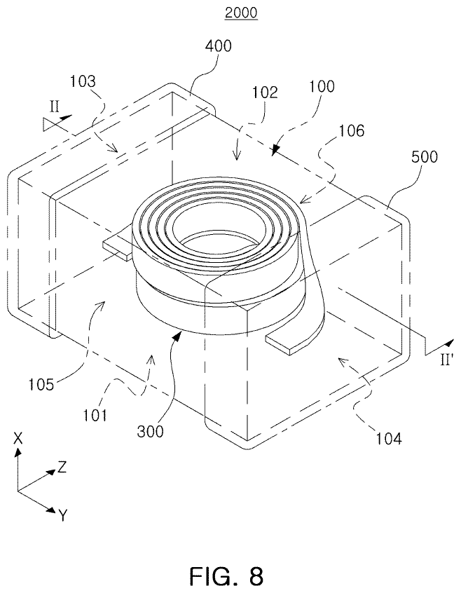

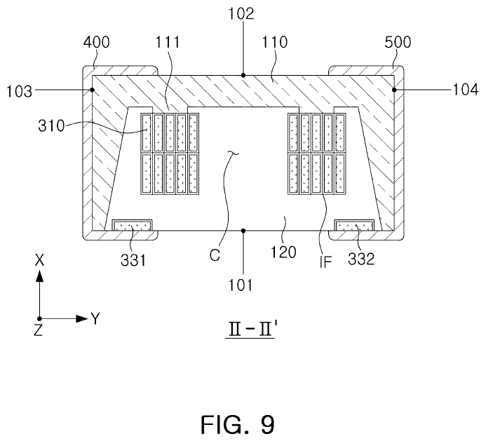

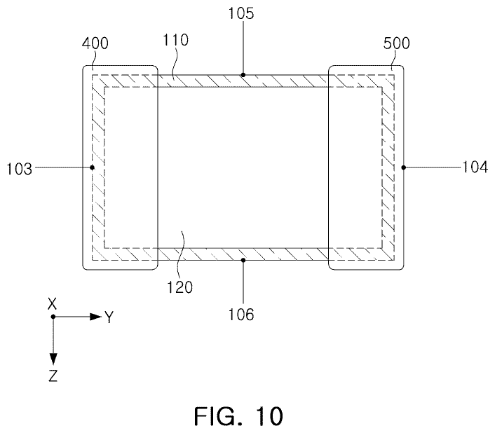

FIG. 8 is a perspective view schematically illustrating a coil component according to another embodiment of the present disclosure. FIG. 9 is a cross-sectional view taken along line II-II′ of FIG. 8. FIG. 10 is a view viewed in the X-direction of FIG. 8.

Hereinafter, a coil component 2000 according to a second embodiment of the present disclosure will be described with reference to FIGS. 8 to 10.

The coil component 2000 according to a second embodiment of the present disclosure is different from the first embodiment in the shape of the cover portion 110 and the position of the two ends of the coil 300, etc. Hereinafter, the differences compared to the first embodiment will be described.

The cover portion 110 may cover a plurality of side surfaces of the molded portion. As shown in FIGS. 9 and 10, the cover portion 110 may be formed to surround the molded portion 120 by covering a plurality of four side surfaces of the molded portion 120. Accordingly, the plurality of side surfaces of the cover portion 110 may form the plurality of side surfaces 103, 104, 105, and 106 of the body 100, and the plurality of side surfaces of the molded portion 120 may not extend to the outer surface of the body 100.

The relief pattern 111 may be spaced apart from the plurality of side surfaces 103, 104, 105, and 106 of the body 100. That is, as the shape of the cover portion 110 changes, the relief pattern 111 may not extend to the plurality of side surfaces 103, 104, 105, and 106 of the body 100.

Both ends of the coil 300 may extend to the first surface 101 of the body 100, not the first side surface 103 and the second side surface 104. That is, as the shape of the cover portion 110 is changed, both ends of the coil 300 may extend to the lower surface rather than the side surface of the body 100.

The first and second external electrodes 400 and 500 may be disposed to be spaced apart from each other on the first surface 101 of the body 100 in the second direction (the Y-direction). However, without being limited thereto, the first external electrode 400 may extend to at least a portion of each of the first side surface 103, the third surface 105, the fourth surface 106, and the second surface 102 of the body 100. Similarly, the second external electrode 500 may extend to at least a portion of each of the second to fourth side surfaces 104, 105, and 106 of the body 100 and the second surface 102 of the body 100.

Descriptions of other components may be the same as those of the first embodiment and are therefore omitted.

According to the embodiments of the present disclosure, a coil component with improved reliability by controlling crack occurrence within a magnetic body may be provided.

While example embodiments have been shown and described above, it will be apparent to those skilled in the art that modifications and variations could be made without departing from the scope of the present disclosure as defined by the appended claims.

What is claimed is:

1. A coil component comprising:
a body including a first surface and a second surface opposing each other in a first direction and a plurality of side surfaces connecting the first surface and the second surface and including a magnetic material;
a coil disposed within the body; and
first and second external electrodes disposed to be spaced apart from each other on the body in a second direction and connected to both ends of the coil,
wherein the body includes a molded portion in which the coil is disposed and a cover portion including one surface in contact with the molded portion, a relief pattern protrudes from the one surface of the cover portion, and when viewed in the first direction, at least a portion of the relief pattern overlaps the coil.

2. The coil component of claim 1, wherein, when viewed in the first direction, the relief pattern has a radial shape from a center of the one surface of the cover portion to an outer portion.

3. The coil component of claim 1, wherein the molded portion includes a core penetrating through the coil.

4. The coil component of claim 1, wherein, when viewed in the first direction, the relief pattern overlaps the core.

5. The coil component of claim 1, further comprising:
an insulating film covering the coil,
wherein the relief pattern is in contact with the insulating film.

6. The coil component of claim 1, wherein the relief pattern does not penetrate through the coil.

7. The coil component of claim 1, wherein the cover portion further includes an other surface opposing the one surface in the first direction and a plurality of side surfaces connecting the one surface and the other surface, the other surface of the cover portion forms the second surface of the body, and the plurality of side surfaces of the cover portion form the plurality of side surfaces of the body.

8. The coil component of claim 1, wherein
the cover portion includes a first magnetic metal particle,
the molded portion includes a second magnetic metal particle, and
the cover portion and the molded portion have different particle size distributions.

9. The coil component of claim 1, wherein the both ends of the coil extend to both sides facing each other in the second direction of the body.

10. The coil component of claim 1, wherein
the molded portion includes one surface forming the first surface of the body, an other surface facing the one surface in the first direction and contacting the cover portion, and a plurality of side surfaces connecting the one surface and the other surface, and the cover portion covers the plurality of side surfaces of the molded portion.

11. The coil component of claim 1, wherein the relief pattern is spaced apart from the plurality of side surfaces of the body.

12. The coil component of claim 1, wherein the both ends of the coil extend to the first surface of the body.

13. A coil component comprising:
a body including a first surface and a second surface opposing each other in a first direction and a plurality of side surfaces connecting the first surface and the second surface and including a magnetic material;
a coil disposed within the body and forming at least one turn; and
first and second external electrodes disposed to be spaced apart from each other on the body in a second direction and connected to both ends of the coil,
wherein the body includes a molded portion in which the coil is disposed and a cover portion including one surface in contact with the molded portion, a relief pattern protrudes from the one surface of the cover portion, and when viewed in the first direction, the relief pattern is spaced apart from the plurality of side surfaces of the body.

14. The coil component of claim 13, wherein the molded portion includes one surface forming the first surface of the body, an other surface facing the one surface in the first direction and contacting the cover portion, and a plurality of side surfaces connecting the one surface and the other surface, and the cover portion covers the plurality of side surfaces of the molded portion.

15. The coil component of claim 13, wherein the both ends of the coil extend to the first surface of the body.

16. The coil component of claim 13, wherein the relief pattern comprises a beam-like relief structure disposed on a lower surface of the cover portion.
